(19) United States
(12) Patent Application Publication
(10) Pub. No.: US 2015/0241655 A1
(43) Pub. Date: Aug. 27, 2015

(54) CABLE STRAIN RELIEF DEVICE, ASSEMBLY AND METHOD

(71) Applicant: Corning Optical Communications LLC, Hickory, NC (US)

(72) Inventors: Alan Duncan Burkett, Bedford, TX (US); Terry Dean Cox, Fort Worth, TX (US)

(21) Appl. No.: 14/625,177

(22) Filed: Feb. 18, 2015

Related U.S. Application Data
(60) Provisional application No. 61/942,827, filed on Feb. 21, 2014.

(51) Int. Cl. G02B 6/44

(52) U.S. Cl. CPC G02B 6/4471

(57) ABSTRACT

A fiber optic cable strain relief device having a plurality of post mounted to a mounting surface is described. The plurality of posts have a first end, a second end and a shaft extending between the first and second ends. The mounting surface is adapted to support the posts, with the posts mounting to the mounting surface at their respective first ends and extending from the mounting surface. The posts are mounted to the mounting surface such that the shafts of adjacent posts are spaced from each other by a distance configured to provide strain relief to a fiber optic cable weaved about the shafts of the adjacent posts. The mounting surface may be attached to a housing and a cover positioned over the posts.

### RELATED APPLICATIONS

This application claims the benefit of priority under 35 U.S.C. §119 of U.S. Provisional Application No. 61/942,827 filed on Feb. 21, 2014, the content of which is relied upon and incorporated herein by reference in its entirety.

### BACKGROUND

1. Field

The disclosure relates generally to a device and assembly that strain relief cables, particularly fiber optic cables, in efficient use of space.

2. Technical Background

Optical fibers are widely used in a variety of applications, including the telecommunications industry in which optical fibers are employed in a number of telephony and data transmission applications. Due, at least in part, to the extremely wide bandwidth and the low noise operation provided by optical fibers, the use of optical fibers and the variety of applications in which optical fibers are used are continuing to increase. To effectively and safely route optical fibers between connection points, single or multiple optical fibers may be arranged in a fiber optic cable. Typically, the fiber optic cable may comprise some form of jacketing or covering to protect the optical fiber from damage due to environmental conditions and handling. Additionally, fiber optic cables protect the optical fibers from damage due to tension or stress. This protection may include a strength member that runs the length of the fiber optic cable and designed to sustain the tensioning or stressing instead of the optical fibers.

Even with such protection, forces may strain the optical fibers and the connections attached to the ends of the optical fibers. Therefore, strain relief devices may be applied to fiber optic cables. Strain relieving a fiber optic cable is typically performed to prevent undue strain on the connectors and other more sensitive components. Conventional strain relief devices and methods involve multiple time consuming steps as well as potential pressure points that could damage the optical fiber. Typical strain relief devices and methods may involve clamps, fasteners, shims and various other components which require multiple time-consuming steps to accomplish the desired result. Such strain relief devices occupy valuable space in the fiber optic equipment, space that, more preferably, could be used for increasing the connection density of the fiber optic equipment.

No admission is made that any reference cited herein constitutes prior art. Applicant expressly reserves the right to challenge the accuracy and pertinence of any cited documents.

### SUMMARY

Embodiments disclosed herein include a fiber optic cable strain relief device having a plurality of post mounted to a mounting surface. The plurality of posts have a first end, a second end and a shaft between the first and second ends. The mounting surface is adapted to support the plurality of posts, with ones of the plurality of posts mounting to the mounting surface at their respective first ends and extending from the mounting surface. The plurality of posts are mounted to the mounting surface such that the shafts of adjacent ones of the plurality of posts are spaced from each other by a distance configured to provide strain relief to a fiber optic cable weaved about the shafts of the adjacent ones of the plurality of posts. Such distance may provide to the fiber optic cable about 4% of interference with the shafts to about 12% of clearance between the shafts. Additionally, the distance between center lines of adjacent ones of the plurality of posts may be equal to an outside diameter of the fiber optic cable to be strain relieved multiplied by 2.125. The plurality of posts may be configured to increase strain relief holding force of a fiber optic cable by a factor of about 12.

One embodiment of the disclosure relates to a fiber optic cable strain relief device having a first post, a second post and a third post each having a first end, a second end and a shaft extending between the first end and second end and mounted to a mounting surface at their respective first ends and extending from the mounting surface. The first post, the second post and the third post are aligned such that a fiber optic cable weaved about the shafts of the first post, the second post and the third post forms a 90 degree arc around the first post, a 180 degree arc around the second post and a 90 degree arc around the third post.

An additional embodiment of the disclosure relates to a fiber optic cable strain relief assembly, comprising a first plurality of posts and a second plurality of posts. Ones of the first and the second plurality of posts have a first end, a second end and a shaft between the first end and second end. a mounting surface is adapted to support the first plurality of posts and the second plurality of posts with the ones of the first plurality of posts and the ones of the second plurality of posts mounting to the mounting surface at their respective first ends and extend from the mounting surface. The first plurality of posts is mounted to the mounting surface such that shafts of adjacent ones of the first plurality of posts are spaced from each other by a distance configured to provide strain relief to a first fiber optic cable weaved about the shafts of the adjacent ones of the first plurality of posts. The second plurality of posts is mounted to the mounting surface such that the shafts of adjacent ones of the second plurality of posts are spaced from each other by a distance configured to provide strain relief to a second fiber optic cable weaved about the shafts of the adjacent ones of the second plurality of posts.

An additional embodiment of the disclosure relates to a method of strain relieving a fiber optic cable involving providing a mounting surface and a plurality of posts with ones of the plurality of posts having a first end, a second end and a shaft between the first end and the second end. The method also includes mounting the ones of the plurality of posts to the mounting surface at their respective first ends such that the plurality of posts extend from the mounting surface. The ones of the plurality of posts are mounted to the mounting surface such that the shafts of adjacent ones of the plurality of posts are spaced from each other by a distance configured to provide strain relief to a fiber optic cable weaved about the shafts of the adjacent ones of the plurality of posts.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary embodiment of fiber optic cable strain relief device comprising a plurality of posts spaced at a distance and mounted to a mounting surface with the route of a fiber optic cable to be strain relieved shown weaved about the plurality of posts;

FIG. 2 is a front, right perspective view of fiber optic cable strain relief device of FIG. 1;

FIG. 3 is a detail, end view of one of the posts of the plurality of posts of FIG. 1;

FIG. 4 is a detail view of two posts of the plurality of posts of FIG. 1 with a fiber optic cable between them illustrating interference of the fiber optic cable by the posts;

FIG. 5 is a detail view of two posts of the plurality of posts of FIG. 1 with a fiber optic cable between them illustrating clearance between the fiber optic cable and the posts;

FIG. 6 is a graph of amplification of the strain relief holding force plotted against the angle of the bend of a fiber optic cable around one or more of the plurality of posts of FIG. 1;

FIG. 7 is an exemplary embodiment of a fiber optic cable strain relief assembly having an array of pluralities of posts of FIG. 1 having three posts each and aligned in separate rows;

FIG. 8 is a top view of an exemplary embodiment of a fiber optic cable strain relief assembly;

FIG. 9 is a front, right perspective view of the fiber optic cable strain relief assembly of FIG. 8 attached to a housing; and

FIGS. 10A-10F are front, right perspective views of an exemplary embodiment illustrating of a housing having two fiber optic cable strain relied assemblies of FIG. 7 attached in a stacked fashion one on top of the other, the removal of the top fiber optic cable strain relied assembly from the housing, the placement of fiber optic cables on the bottom fiber optic cable strain relief assembly, and the re-attachment of the top fiber optic cable strain relied assembly to the housing.

### DETAILED DESCRIPTION

Embodiments disclosed herein include a fiber optic cable strain relief device having a plurality of post mounted to a mounting surface. The plurality of posts have a first end, a second end and a shaft between the first and second ends. The mounting surface is adapted to support the plurality of posts, with ones of the plurality of posts mounting to the mounting surface at their respective first ends and extending from the mounting surface. The plurality of posts are mounted to the mounting surface such that the shafts of adjacent ones of the plurality of posts are spaced from each other by a distance configured to provide strain relief to a fiber optic cable weaved about the shafts of the adjacent ones of the plurality of posts. The shafts of the adjacent ones of the plurality of posts may be spaced by a distance to provide to the fiber optic cable about 4% of interference with the shafts to about 12% of clearance between the shafts. The distance between center lines of adjacent ones of the plurality of posts may be equal to an outside diameter of the fiber optic cable to be strain relieved multiplied by 2.125. Moreover, the plurality of posts may be configured such that strain relief holding force of a fiber optic cable may be increased by a factor, including up to about 12.

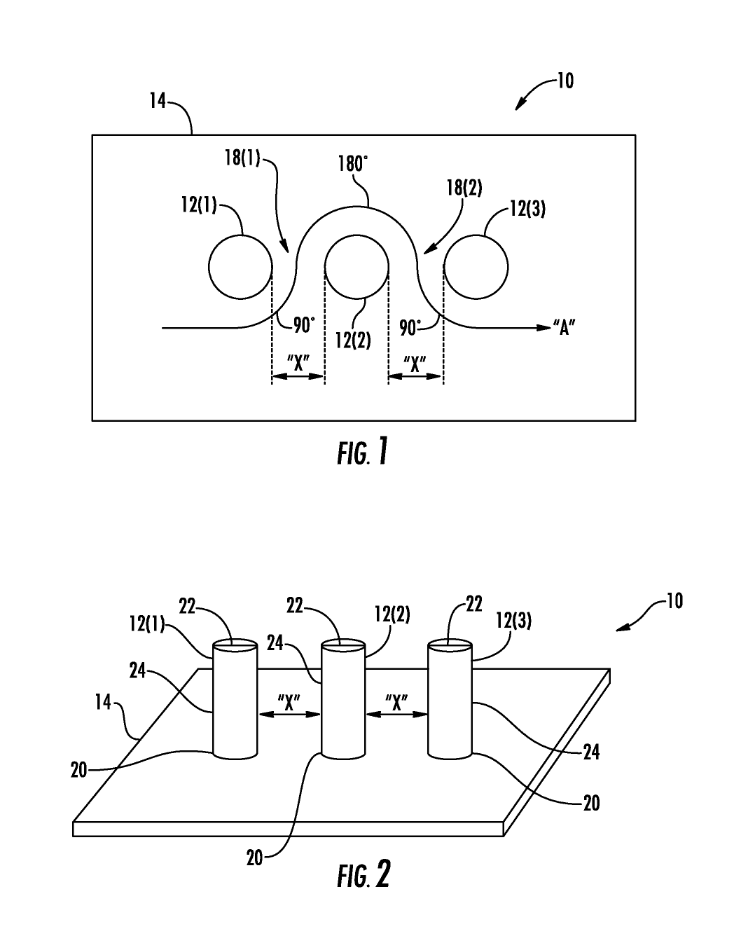

In this regard, FIGS. 1 and 2, illustrate a fiber optic cable strain relief device 10 having a plurality of posts 12 mounted to a mounting surface 14 such that adjacent posts 12 are spaced at a distance “X”. In FIG. 1, route “A” of a fiber optic cable 16 (not shown in FIG. 1) to be strain relieved is shown weaved about the plurality of posts 12. Weaving the fiber optic cable 16 about the plurality of posts 12 may include passing the fiber optic cable 16 through the spaces 18 between adjacent posts 12 in alternating directions. In FIG. 1, three posts, first post 12(1), second post 12(2) and third post 12(3) are shown, but any number of posts 12 may be used. Referring briefly to FIG. 2, the posts 12 have a first end 20, a second end 22 and a shaft 24 between first end 20 and second end 22. The posts 12 mount to the mounting surface 14 at first end 20 and extend from the mounting surface 14. Posts 12 may be mounted to the mounting surface 14 using any appropriate method. Additionally, the posts 12 may be formed monolithically with the mounting surface 14 using the same material as the mounting surface 1 for at least part of the posts 12.

In FIG. 1, the route “A” of the fiber optic cable 16 is shown as forming an angle about first post 12(1), a 180 degree angle about second post 12(2) and a 90 degree angle about third post 12(3). As can be seen in FIG. 1, the route “A” of the fiber optic cable 16 passes through first space 18(1) in a first direction and through second space 18(2) in a second direction thereby passing through spaces 18(1), 18(2) between adjacent posts 12(1), 12(2), 12(3) in alternating directions. Therefore, the total angular displacement of the fiber optic cable 16 following route “A” is 90 degrees plus 180 degrees plus 90 degrees or 360 degrees. In other words, the fiber optic cable 16 is in contact with shaft 24 of first post 12(1), shaft 24 of second post 12(2) and shaft 24 of third post 12(3) an aggregate total of 360 degrees. Accordingly, the fiber optic cable strain relief device 10 shown in FIG. 1 provides a total effective cable wrap of 360 degrees, as if the fiber optic cable 16 was wrapped completely around the shaft 24 of just one of the posts 12. As shown in FIG. 1, fiber optic cable 16 following route “A” may pass about first post 12(1), second post 12(2) and third post 12(3) without completely wrapping coiling about any one of the posts 12(1), 12(2), 12(3), thereby facilitating installation of the fiber optic cable 16 on the fiber optic strain relief device 10.

The total effective cable wrap with the coefficient of friction directly contacting the post determines the holding strength of the posts 26 to the fiber optic cable. The capstan equation or belt-friction equation may be used for determining such holding strength:

T₁=T₂×e^{μθ}

### Where:

T₁ is the applied tension or load on the fiber optic cable,

T₂ is the holding force or resulting force exerted on the other side of the post 12,

μ is the coefficient of friction, and

θ is the total angular displacement of the fiber optic cable 16 on the post 12.

For the purposes of the equation, the coefficient of friction is 0.4. The total angular displacement of the coaxial cable about the posts 26, as discussed above and shown in FIG. 1, is 360 degrees. Calculating e^{μθ} using the above values for μ and θ results in the value of 12. Therefore, a holding force of a certain value can hold a load equal to 12 times the holding force. Accordingly, e^{μθ} provides a multiplier of the holding force. The holding force may also be used as a “Strain Relief Factor,” for understanding the effective strain relief that is being applied to the fiber optic cable 16 by the posts 12.

The Strain Relief Factor for different angular displacements of the fiber optic cable 16 about the posts 12 is shown on the graph in FIG. 3, where the e^{μθ} value, titled “amplification”, is plotted against the angular displacement of the fiber optic cable 16. As can be seen from FIG. 3, the Strain Relief Factor increases to 12 as the total angular displacement reaches 360 degrees or one effective complete wrap of the fiber optic cable 16 around one post 26. Although not plotted on the graph in FIG. 3, increasing the angular displacement more than 360 degrees results in the Strain Relief Factor continuing to increase exponentially. For example, for two effective complete wraps of a fiber optic cable 16 or 720 degree angular displacement, the Strain Relief Factor is 152.

With reference again to FIG. 1, distance “X” of space 18 is configured such that the fiber optic cable 16 can weave about posts 12 to result in the total angular displacement of 360 degrees as discussed above. If the space 18 is too small, the fiber optic cable 16 cannot be weaved about the adjacent posts 12. If the space 18 is too large, the fiber optic cable 16 will not contact the posts 12 a total of 360 degrees. In this regard, “X” may be based on the size and shape of the posts 12 and the outside diameter of the fiber optic cable 16 to be strain relieved. In this way, the posts 12 and space 18, may be configured to provide strain relief to a fiber optic cable 16 weaved about the shafts 24 of adjacent ones of the plurality of posts 12. The distance “X” for space 18 may be determined by first calculating the centerline to centerline distance of adjacent posts 12. In this regard:

D_{CL}=(OD_{C}+OD_{P})×1.0625

### Where:

D_{CL} is the centerline to centerline distance between adjacent posts 12.

OD_{C} is the nominal outside diameter of the fiber optic cable 16.

OD_{P} is the nominal outside diameter of the post 12 or the flat-to-dimension if the post 12 is has a polygonal cross-section.

As an example:
Assume that

OD_{C}=4.8 mm, and

OD_{P}=4.8 mm, then

D_{CL}=(4.8 mm+4.8 mm)×1.0625=10.2 mm

To find distance “X” for space 18:

X=D_{CL}−2(OD_{P})/2=10.2−4.8=5.4 mm.

Whether the post 12 has a cross-section that is generally circular or arcuate or polygonal, distance X of 5.4 mm allows sufficient clearance for the fiber optic cable 16 having an OD_{C} of 3.4 mm to pass between adjacent posts 12, and still contact the shafts 24 of the adjacent posts 12 as the fiber optic cable 16 weaves about the posts 12 in a manner to establish the angular displacement of the fiber optic cable 16 against the post 12.

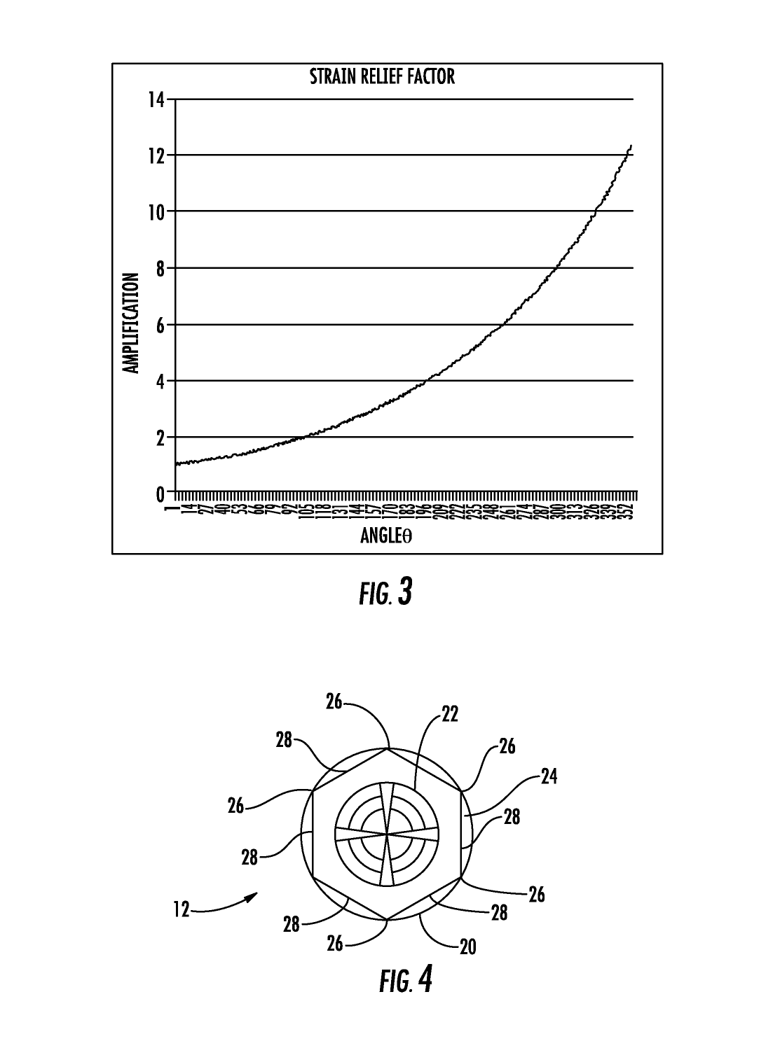

With reference now to FIG. 4, an exemplary embodiment of post 12 is shown with post 12 viewed from the second end 22. As can be seen in FIG. 3, while first end 20 has a circular cross-section shape, shaft 24 has a hexagonal cross-section shape. The hexagonal shape has 6 points 26 and 6 flat sections 28. One or more of points 26 may pierce the cable jacket of the fiber optic cable 16 a certain depth to provide interference, while one or more of the flat sections 28 provide clearance to fiber optic cable 16 as fiber optic cable 16 weaves about the shafts 24 of adjacent posts 12. Therefore, the space 18 having a distance “X” may be measured from a flat-to-flat of shafts 24 of adjacent posts 21. As calculated in the above example, “X” equaled 5.4 mm. Although not shown in FIG. 4, the cross section of shaft 24 can be any shape, including any regular polygon with any number of points 26, or generally or partially circular or other arcuate shape. Additionally, posts of various materials or material combinations, as non-limiting example, metal such as non-limiting examples stainless, aluminum and brass, metal core with an over molded thermoplastic elastomer, or posts having any type of surface finish as non-limiting examples, knurled or roughened, can be used. Different material and surface finishes can be used to increase the effective coefficient of friction between the fiber optic cable and the post or to otherwise increase the holding strength of the post on the fiber optic cable calculated as a multiple of the coefficient of friction.

FIG. 5 illustrates a fiber optic cable 16 passing between two posts 12 each having a hexagonal cross-section. The fiber optic cable 16 passes between two posts 12 with distance “X” such that flat sections 28 of each post 12 provide clearance between the fiber optic cable 16 and the posts 12. About a 12% clearance is desired to provide sufficient space around the shafts 24 of adjacent posts 12 to facilitate installation of the fiber optic cable 16. Otherwise the fiber optic cable 16 may be difficult to install without damaging the fiber optic cable 16 upon installation and upon the fiber optic cable 16 being weaved about the posts 12. The following equation may be used to determine if the distance “X” provides sufficient clearance to facilitate installation of the fiber optic cable 16:

C=X−OD_{C} and C_{F}=C/OD_{C}

### Where:

C is the clearance dimension.

X is the space 18 between posts 12.

OD_{C} is the nominal outside diameter of the fiber optic cable 16.

C_{F} is the clearance factor in percentage.

Using the values:

X=5.4 mm. and

OD_{C}=4.8 mm

### Then:

C32 5.4 mm−4.8 mm =0.6 mm and C_{F}=0.6 mm/4.8 mm=12.5%

Accordingly, a distance “X” of 5.4 mm would result in a clearance factor sufficient for the installation of a fiber optic cable 16 having an OD_{C} of 4.8 mm.

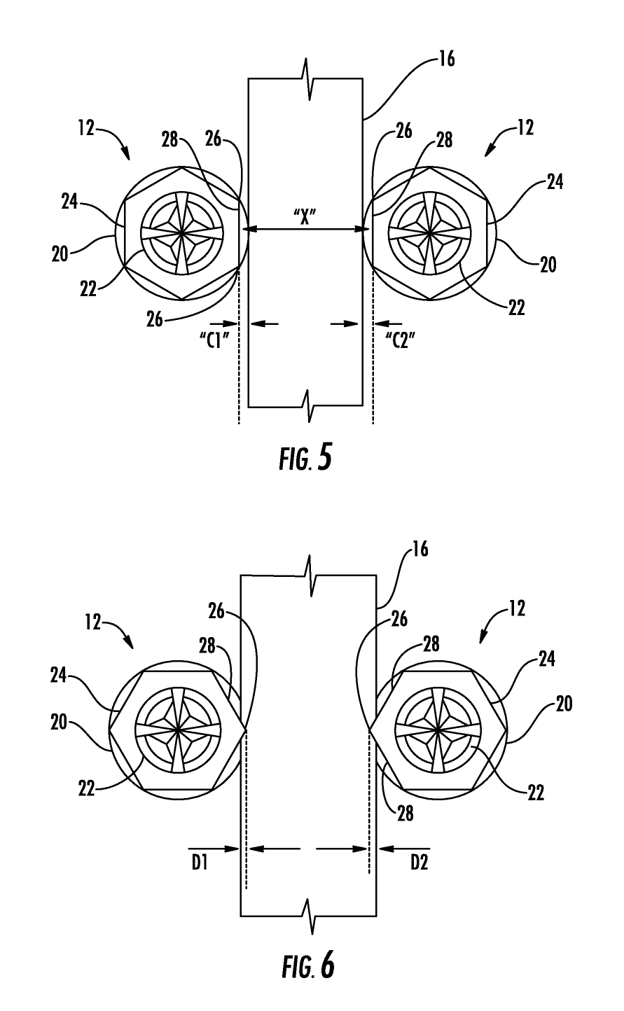

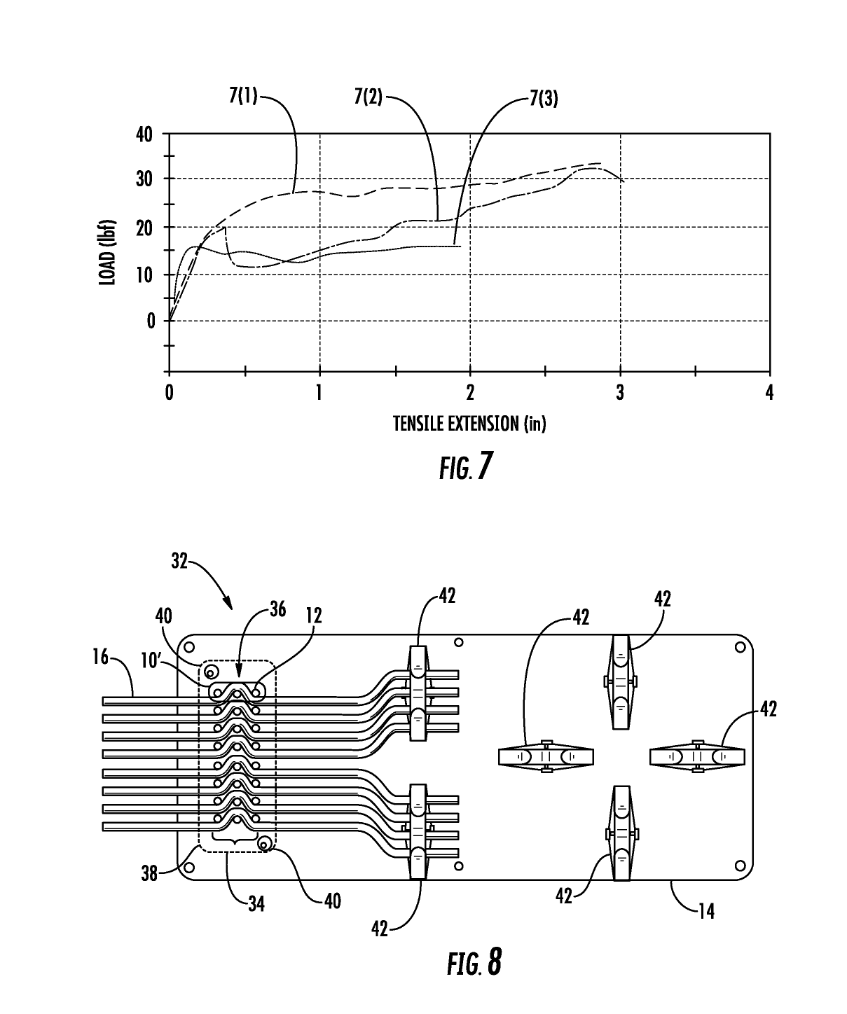

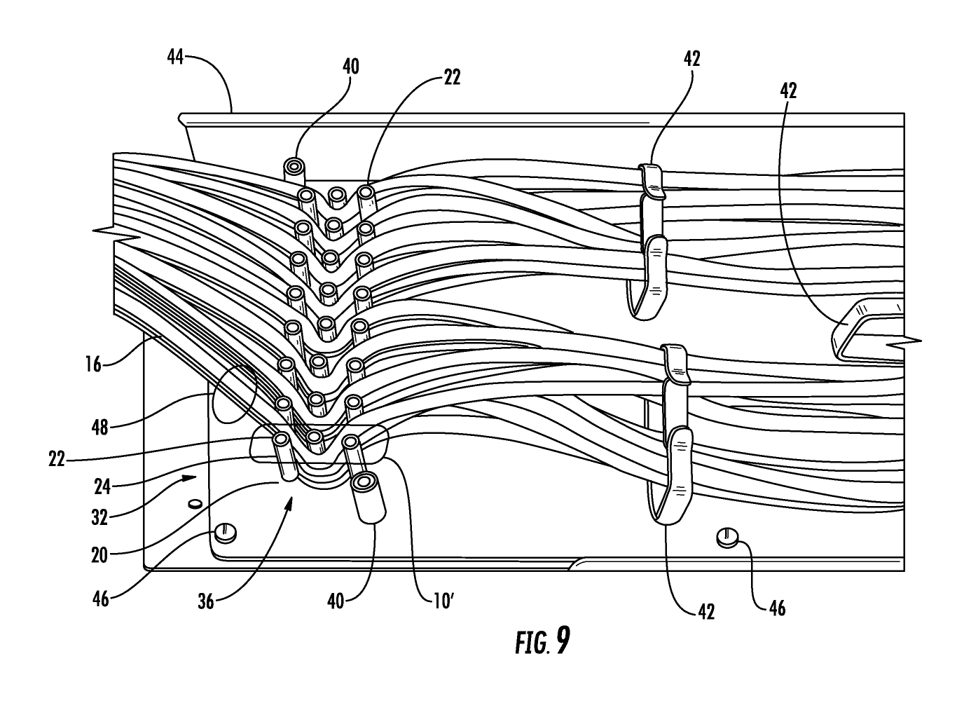

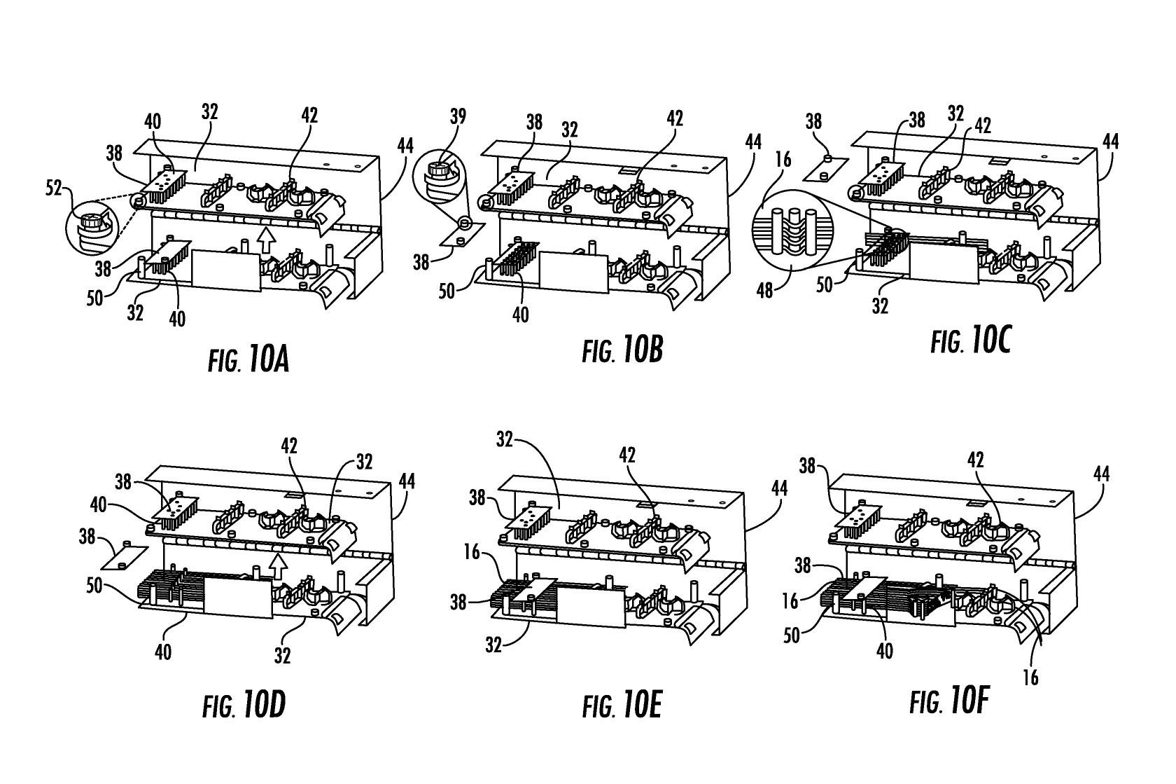

FIG. 6 shows the fiber optic cable 16 passing between two posts 12 with a point 26 on each of posts 12 piercing the cable jacket 30 of the fiber optic cable 16. In the embodiment shown in FIG. 6, each point 26 pierces the cable jacket 30 to a certain depth. By piercing the cable jacket 30 the points 26 increase the holding force of the posts 12 as if the coefficient of friction between the posts 12 and the fiber optic cable 16 were increased. In other words, the piercing depth of points 26 increases the holding force of fiber optic cable strain relief device 10. About a 2% interference is desired to sufficiently increase the holding force and not affect the ability to install the fiber optic cable 16 about the shafts 24 of the posts 12. The following equation may be used to determine if a pierce depth of:

In FIG. 6, point 26 of each post 12 pierces the fiber optic cable 16 a depth of about 0.1 mm resulting in a total piercing depth of about 0.2 mm. Although a piercing depth of about 0.1 mm is shown on FIG. 6, the piercing depth is not limited to that depth and it should be understood that point 26 may pierce the cable jacket 30 to any depth. As mentioned above, and although not shown in FIG. 5, the shaft 24 can be any cross section including shapes with any number of points 26, or generally or partially circular or other arcuate shape. In the case of a generally or partially circular or other arcuate shape, the interference would be caused by the number of actual or effective contact points of the cable jacket 30 on the shaft 24 calculated using the coefficient of friction.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A fiber optic cable strain relief device, comprising:
a plurality of posts, wherein ones of the plurality of posts have a first end, a second end and a shaft between the first end and the second end; and
a mounting surface adapted to support the plurality of posts, wherein the ones of the plurality of posts mount to the mounting surface at their respective first ends and extend from the mounting surface, and
wherein the ones of the plurality of posts are mounted to the mounting surface such that the shafts of adjacent ones of the plurality of posts are spaced from each other by a distance configured to provide strain relief to a fiber optic cable weaved about the shafts of the adjacent ones of the plurality of posts.

2. The fiber optic cable strain relief device of claim 1, wherein the shafts of the adjacent ones of the plurality of posts are spaced by a distance to provide to the fiber optic cable about 4% of interference with the shafts to about 12% of clearance between the shafts.

3. The fiber optic cable strain relief device of claim 1, wherein a distance between center lines of adjacent ones of the plurality of posts is equal to an outside diameter of the fiber optic cable to be strain relieved multiplied by 2.125.

4. The fiber optic cable strain relief device of claim 1, wherein the plurality of posts comprises a first post, a second post and a third post.

5. The fiber optic cable strain relief device of claim 4, wherein the first post, the second post and the third post are aligned such that a fiber optic cable weaved about the shafts of the first post, the second post and the third post forms a 90 degree arc around the first post, a 180 degree arc around the second post and a 90 degree arc around the third post.

6. The fiber optic cable strain relief device of claim 1, wherein at least one of the plurality of posts has a shaft with a hexagonal cross-section.

7. The fiber optic cable strain relief device of claim 6, wherein a point formed by the hexagonal cross-section of the shaft provides interference to the fiber optic cable.

8. The fiber optic cable strain relief device of claim 1, wherein the plurality of posts are configured to increase strain relief holding force of a fiber optic cable by a factor of about 12.

9. The fiber optic strain relief device of claim 1, wherein the shaft of one of the plurality of posts is designed to strain relief a plurality of fiber optic cables.

10. A fiber optic cable strain relief assembly, comprising:
a first plurality of posts, wherein ones of the first plurality of posts have a first end, a second end and a shaft between the first end and the second end;
a second plurality of posts adjacent to the first plurality of posts, wherein ones of the second plurality of posts have a first end, a second end and a shaft between the first end and the second end; and
a mounting surface adapted to support the first plurality of posts and the second plurality of posts, wherein the ones of the first plurality of posts and the ones of the second plurality of posts mount to the mounting surface at their respective first ends and extend from the mounting surface, and
wherein the first plurality of posts is mounted to the mounting surface such that the shafts of adjacent ones of the plurality of posts are spaced from each other by a distance configured to provide strain relief to a first fiber optic cable weaved about the shafts of the adjacent ones of the first plurality of posts, and wherein the second plurality of posts is mounted to the mounting surface such that the shafts of adjacent ones of the second plurality of posts are spaced from each other by a distance configured to provide strain relief to a second fiber optic cable weaved about the shafts of the adjacent ones of the second plurality of posts.

11. The fiber optic cable strain relief assembly of claim 10, wherein the first plurality of posts and the second plurality of posts are aligned in separate rows from each other to form an array.

12. The fiber optic cable strain relief assembly of claim 11, further comprising at least one other plurality of posts aligned in a separate row from the first plurality of posts and the second plurality of post in the array.

13. The fiber optic cable strain relief assembly of claim 10, further comprising a cover positioned over the first plurality of posts and the second plurality of posts.

14. The fiber optic cable strain relief assembly of claim 13, further comprising at least one support attached to the mounting surface and adapted to support the cover.

15. The fiber optic cable strain relief assembly of claim 14, wherein the cover tool-lessly attaches to the support.

16. The fiber optic cable strain relief assembly of claim 14, wherein the cover attaches to the support using a tool-less fastener.

17. The fiber optic cable strain relief assembly of claim 10, wherein the mounting surface is configured to attach to a housing.

18. A method of strain relieving a fiber optic cable, comprising:
providing a mounting surface;
providing a plurality of post with ones of the plurality of posts having a first end, a second end and a shaft between the first end and the second end;
mounting the ones of the plurality of posts to the mounting surface at their respective first ends such that the plurality of posts extend from the mounting surface, wherein the ones of the plurality of posts are mounted to the mounting surface such that the shafts of adjacent ones of the plurality of posts are spaced from each other by a distance configured to provide strain relief to a fiber optic cable weaved about the shafts of the adjacent ones of the plurality of posts.

19. The method of claim 18, wherein the plurality of posts comprise a first plurality of posts and a second plurality of posts, and further comprising aligning the first plurality of post and the second plurality of post in separate rows.

20. The method of claim 19, wherein the first plurality of posts and the second plurality of posts each comprise a first post, a second post and a third post.

21. The method of claim 18, further comprising attaching the mounting surface to a housing.
